(19) United States
(12) Patent Application Publication
(10) Pub. No.: US 2008/0302910 A1
(43) Pub. Date: Dec. 11, 2008

(54) Aircraft Fuselage Heating

(76) Inventor: Hal Errikos Calamvokis, London (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 12/158,600

(22) PCT Filed: Dec. 21, 2006
(86) PCT No.: PCT/GB2006/004872

§ 371 Date: Aug. 1, 2008

(30) Foreign Application Priority Data
Dec. 22, 2005 (GB) 0526190.4

(51) Int. Cl. B64D 13/08

(52) U.S. Cl. 244/118.5

(57) ABSTRACT

A method of heating an aircraft fuselage comprises the step of supplying heat energy to air occupying an interior space enclosed by an aircraft fuselage shell structure so as to drive moisture from air in a region disposed immediately adjacent the structure to air in a region disposed from the structure within the enclosed space (20), thereby substantially preventing ice formation on the interior of the structure when the exterior of the structure is exposed to temperatures in the region of −35° C. to −85° C. The heat energy may be supplied by either a heater mat or a heat pipe assembly (16) in an aircraft fuselage.

### FIELD OF THE INVENTION

The present invention relates to a method of heating a passenger or transport aircraft fuselage, devices therefor and an aircraft fuselage so heated.

### BACKGROUND TO THE INVENTION

Commercial passenger and transport aircraft having jet engines as their propulsion system typically cruise at an altitude of around 11,000 m. At these high altitudes jet engines are particularly efficient, the aerodynamic drag penalty on the aircraft is significantly reduced when compared with cruising at lower altitude, and the aircraft is less susceptible to weather considerations. Accordingly, aircraft cruising at such high altitudes may do so efficiently and in a shorter overall trip time.

A disadvantage of flying at these high altitudes is that the aircraft is often exposed to freezing temperatures of up to around −85° C. Some form of insulation and heating is therefore needed for human beings to survive at these temperatures. A solution often used in military jet aircraft is to provide the crew with clothes that provide enough thermal insulation and/or heating for them to perform their tasks in comfort, usually in conjunction with an oxygen mask. This solution is not practical for many passenger and transport aircraft. Traditionally, insulation, so-called “blankets”, are therefore fitted against the inside of the aircraft fuselage and cabin air within the fuselage is heated, usually by the use of “bleed air” extracted from the gas path of aircraft engines or by an electrical or hydraulic system deriving its energy from the aircraft engines.

The cabin air is generally pressurized to a higher pressure than that of the ambient air outside the aircraft at cruise altitude and the act of pressurising ambient or bleed air to the pressure of the cabin air generally has a side effect of heating it up. One potential problem with bleed air is that it can be extracted from the engine compressor stage at temperatures up to 300° C., which is ideal for another use of bleed air in wing and nacelle anti-icing but this may require bleed air to be cooled before its introduction to the cabin after it has been pressurised up to the required cabin air pressure. Air Cycle Machines (ACMs) are often installed onboard passenger jet aircraft to manage this problem by exchanging the excess heat with ambient air that has separately been drawn into the ACM and then exhausted from the ACM.

The above described conventional method of heating and insulating passenger and transport aircraft fuselages has a number of disadvantages. Firstly, conventional methods of providing air at the required temperature to the cabin (either through bleed air or via electrical or hydraulic heating systems) impose a fuel burn penalty on the aircraft engines, increasing fuel consumption. Secondly, the heated cabin air can often penetrate around, or through, the insulation blankets, particularly when the cabin air is pressurized. This seeping, moisture laden, warm cabin air may therefore contact the interior side of the aircraft fuselage shell structure comprised traditionally of a skin reinforced with stringers and frames. Since the shell structure typically has an outer aerodynamic surface, which is in direct contact with the freezing ambient air, the moisture in the cabin air may condense and freeze on interior parts of the fuselage shell structure. Once the aircraft descends into warmer air any frozen liquid will thaw. Such freezing and thawing can promote corrosion of the fuselage shell structure if constructed of aluminium, or crack penetration of any microscopic imperfections in the shell structure if constructed of composite materials. In addition, the shell structure (including any fixing brackets for cabin items) may be such that heat paths exist to the cabin side of the insulation blankets from the aerodynamic surface such that exposed portions of the shell structure on the cabin side of the insulation blanket may also reach sub-zero temperatures. In this case, moisture in the cabin air can readily contact the exposed portions of the shell structure and freeze thereupon.

In addition, even if the cabin air is effectively prevented for coming into contact with cold or freezing parts of the shell structure, since the insulation blankets are generally in contact with the shell structure, moisture in the cabin air may condense on an interior surface of the insulation blankets due to local thermal gradient. If the aircraft remains at its cruising altitude for a prolonged period, condensation on the insulation blankets may bead and form water droplets which may flow back into the cabin, an effect called “rain-in-the-plane”.

Not only may the weight of the ice, or trapped water, be carried onboard the aircraft for the remainder of the flight, thus imposing a weight and therefore a fuel penalty, but the lack of moisture in the cabin air may cause discomfort to any passengers. In addition, as the aircraft descends from cruising altitude any ice will melt as the ambient temperature increases, causing potential corrosion issues for any exposed metallic surfaces of the fuselage shell structure.

There is therefore a need for an improved method of heating an aircraft fuselage, devices therefor and an aircraft fuselage so heated.

### SUMMARY OF THE INVENTION

According to a first aspect of the invention, an aircraft fuselage comprises:

an aircraft fuselage shell structure enclosing an interior space; and

a heater disposed in the enclosed space adjacent the aircraft fuselage shell structure for supplying heat energy to air occupying the enclosed space,

wherein the heater is adapted to drive moisture from air in a region disposed immediately adjacent the structure to air in a region disposed from the structure within the enclosed space, thereby substantially preventing ice formation on the interior of the structure when the exterior of the structure is exposed to temperatures in the region of −35° C. to −85° C.

According to a second aspect of the invention, a method of heating an aircraft fuselage comprises the step of supplying heat energy to air occupying an interior space enclosed by an aircraft fuselage shell structure so as to drive moisture from air in a region disposed immediately adjacent the structure to air in a region disposed from the structure within the enclosed space, thereby substantially preventing ice formation on the interior of the structure when the exterior of the structure is exposed to temperatures in the region of −35° C. to −85° C.

The aircraft fuselage of the first aspect and the method of the second aspect of the invention advantageously solve the above-mentioned problems of the prior art. The humidity of the air in the region disposed immediately adjacent the fuselage shell structure is made lower than that in the region disposed from the structure within the enclosed space. The temperature of the aircraft fuselage shell structure is increased by the heat supplied. These combined effects ensure not only that the rate of condensation of moisture from the air on the interior side of the aircraft fuselage shell structure is reduced but also that any condensation that does form has a reduced possibility of freezing. Substantial prevention of ice formation on the interior side of the aircraft fuselage shell structure provides reduced fuel burn for the aircraft in cruise flight and reduced corrosion and damage to the fuselage shell structure. The air occupying the enclosed space is simultaneously heated.

The present invention may reduce the amount of fuselage insulation required thus potentially providing an overall weight loss for the aircraft delivering operational advantages and cost savings.

Also, by driving moisture into the region of air disposed from the fuselage shell structure passengers in the cabin of passenger aircraft may have an improved flight experience due to the greater humidity of the cabin air.

Furthermore, by increasing the temperature of the aircraft fuselage shell structure the invention has the advantage of significantly reducing the occasions when the aircraft fuselage shell structure requires the application of de-icing fluid to its exterior side when the aircraft is on the ground during winter operations. This has a significant bearing on environmental impact of aircraft due to reduced chemical and energy waste, reduced preparation time of aircraft for winter operations, providing reduced operational costs overall.

According to a third aspect of the invention, a heater mat for mounting adjacent an aircraft fuselage shell structure comprises one or more heating elements supported by a support layer, the support layer being permeable to water vapour and impermeable to water droplets, the heater mat being adapted to wick moisture therethrough when energised.

The heater mat of the third aspect of the invention may be used to provide the heating and moisture driving requirements of the first and second aspects. The thermal gradient generated across the support layer dictates the wicking direction to ensure that, when mounted adjacent an aircraft fuselage shell structure, moisture is transferred from the fuselage side of the mat to the cabin side of the mat.

The heating elements are preferably heat pipes but may be electrical resistance heating elements.

According to a fourth aspect of the invention, a heat pipe assembly for mounting adjacent an aircraft fuselage shell structure comprises one or more heat pipes for conveying heated air, the pipe having one or more outlets for directing the heated air onto an aircraft fuselage shell structure, wherein the heat pipe is arcuate and adapted to conform to the curvature of the aircraft fuselage shell structure to which it is to be mounted.

The heat pipe assembly of the fourth aspect of the invention may be used to provide the heating and moisture driving requirements of the first and second aspects. The heated air is driven onto the aircraft fuselage shell structure. Contact with the structure increases the temperature of the fuselage shell structure and re-directs the supplied air towards the interior of the cabin. This airflow substantially prevents moist cabin air from coming into contact with the fuselage shell structure and increases the temperature of the fuselage shell structure. The heat pipes are shaped to conform to the curvature of the aircraft fuselage shell structure to which it is to be mounted so that substantially uniform airflow towards the interior of the cabin can be achieved.

The present invention is multifaceted and the depending claims define further features of preferred embodiments of the present invention.

### BRIEF DESCRIPTION OF THE DRAWINGS

Embodiments of the present invention will now be described with reference to the accompanying drawings in which:

FIG. 1 shows a fuselage cross-section of a conventional aircraft fitted with conventional insulation;

FIG. 2 shows a fuselage cross-section of an aircraft fitted with a heater mat in accordance with an embodiment of the present invention; and

FIG. 3 shows a fuselage cross-section of an aircraft fitted with a heat pipe assembly in accordance with another embodiment of the present invention.

### DETAILED DESCRIPTION

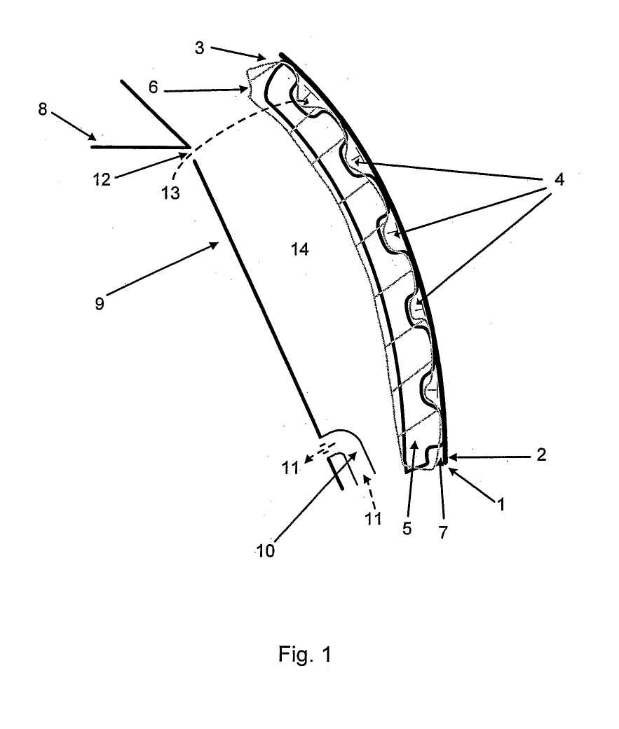

A conventional aircraft fuselage is shown in detail in FIG. 1. The fuselage shell structure comprises a skin 1, an outer surface of which constitutes a smooth aerodynamic surface 2 of the structure, and a reinforcing structure 3. The reinforcing structure 3 is connected to the skin 1 and includes longitudinal stringers 4 and transverse frames 5. Only one frame 5 is shown in the cross-section of FIG. 1. Insulation material 6 is disposed over and between the frames to thermally insulate the skin 1, the aerodynamic surface of which contacts the ambient air outside the aircraft, from the aircraft cabin air. The insulation material 6 covers both the stringers 4 and the frames 5. A Mylar (RTM) blanket is conventionally used as the insulation material 6.

Conventionally, the skin 1, stringers 4 and frames 5 are of aluminium for its combination of strength and low density. In such a construction, these components are generally formed separately and rivetted together with a large number of rivets. The aircraft cabin air of commercial aircraft is typically pressurised to well above ambient pressure during cruise and so the pressure loading in the aircraft fuselage shell structure is significant.

It has recently been proposed to use carbon fibre for the skin 1 and reinforcing structure 3 for a large commercial airliner, the stringers 4 being integrally formed with the skin 1 in a single lay-up and cure. Any cut outs required (for window, doors etc) will then be made and the frames 5 plus any cut out reinforcements required will be applied. The use of carbon fibre rather than aluminium is expected to give significant weight saving since both the strength to weight ratio from carbon fibre is higher than for aluminium but also since the stringers will be integrally formed with the stringers to the exclusion of rivets. However, the proposed carbon fibre integral structure is not different in basic construction to that shown in FIG. 1 and both types of construction will be referred to as “conventional” aircraft structures hereafter.

Some fixtures and fittings of conventional aircraft cabins are generally secured to the fuselage frames 5, but for clarity no such securing members have been shown in FIG. 1. Cabin items such as stowages 8 and cabin panelling 9 are typically of plastics material. An air-conditioning system feeds air including fresh ambient air to the aircraft cabin via various ducts, such as ducting 10 and indicated by airflow 11. The air-conditioning system also includes a system to exhaust stale air from the cabin through skin 1, which has not been shown in FIG. 1 for clarity. The cabin elements are not sealed so that air pressures can equalise across them. Accordingly, gaps such as indicated by 12 exist through which the passage of cabin air from the cabin to the insulation material 6 is made possible, as shown by arrow 13. Cabin air is permitted to circulate around, or through, the insulation material 6 and so can contact an interior surface 7 of the skin 1.

In the cruise, the temperature of the skin is often sub-zero, up to around −85° C. Moist cabin air which contacts the interior skin surface 7 is therefore likely to condense and freeze almost instantaneously. Even if the cabin air is largely prevented from contacting the interior skin surface 7, the moisture in the cabin air is likely to condense upon contact with the insulation material 6. This condensation may be able to drip back into the cabin environment. Where the interior skin surface 7 is of carbon fibre, freeze/thaw damage to the carbon fibre may occur if the moisture is able to penetrate into the carbon fibre. Where the interior skin surface 7 is of metal, even aluminium, then the frozen condensate, when it thaws as the aircraft descends from the cruise, can cause serious corrosion issues at the surface 7.

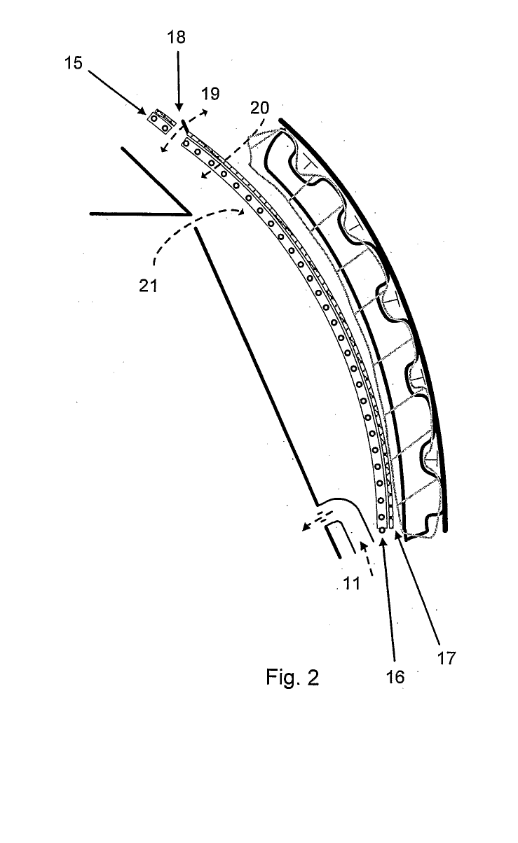

A first embodiment of the invention will now be described with reference to FIG. 2. The aircraft fuselage shell has a similar structure to that of FIG. 1. In addition, a support layer 15 is provided carrying a heating element 16, the support layer 15 being disposed adjacent the insulation material 6 on an interior side of the fuselage shell structure. In this context, “adjacent” means “immediately adjacent” or “near to”. The support layer 15, or an additional layer placed on the fuselage side thereof, is impermeable to water droplets but is permeable to water vapour. Such a construction allows any moisture which is on the fuselage side of the support layer 15 and which condenses on an outer surface of the support layer 15, that is, on the cold side, to wick through the support layer 15 to the warm cabin side of the layer 15. To encourage this effect, the support layer 15 may be provided with a moisture absorbent insulation layer 17 on the fuselage side of the support layer 15. The insulation layer 17 may be constructed of a suitable material such as glass fibre or foam.

In addition to air being able to permeate through the support layer 15, valves 18 or other suitable devices are positioned such that any air located between the support layer 15 and the skin 1 is able to equalise pressure with the cabin air, as shown by arrow 19. This ensures no catastrophic deformation of the support layer 15, or of any other fuselage component, occurs, especially in the event of a rapid decompression of the aircraft cabin at altitude. Thus any moisture in the air between layer 15 and surface 7 is able to condense on the insulation layer 17 (or layer 15 if no additional insulation is fitted) due to the heating effect of heating element 16 and then wick through to the cabin side of layer 15, as indicated by arrow 20. The valve can be operated automatically via a control system or under manual control.

When compared with FIG. 1, the fuselage of FIG. 2 may be constructed having a reduced amount of the insulation material 6 due to the fact that the main body of cabin air is largely (but not totally, for reasons of pressure equalisation) prevented from coming into contact with the sub-zero fuselage shell structure. Also, the insulation layer 17, where provided, can lead to a reduction in the amount of the insulation material 6 required.

In a preferred embodiment the heating element 16 is a heat pipe carrying heated fluid. The fluid may be heated by the aircraft engines through heat exchangers using the “hot end” of the engines as a heat source (typically the turbine, the casing of which can reach several hundred degrees Centigrade during operation). This advantageously provides additional cooling to the engine combustion sections and could reduce thermal stress on critical engine parts, increasing engine time on wing and reducing the degradation in fuel consumption over time. In an alternative embodiment the heating element 16 is an electrical heating wire of a suitable resistance which heats up when an electrical current is passed through it. However, the heating wire may be less efficient than the heat pipe in reducing the fuel burn of the engines, as it will increase the electrical load on the engine driven generators to power the heating wires. The high temperature heating elements lose heat to the fuselage shell structure for anti-icing and to the cabin air for heating the cabin.

The present invention has many advantages including improving passenger experience, since the cabin atmosphere will have a significantly higher relative humidity when compared with conventional cabins, improving comfort on longer flights whilst significantly less condensation and substantially no ice will form against the fuselage shell structure, thus increasing its life. In addition, the energy required to maintain the cabin at a comfortable temperature for passengers would be less.

Whilst the aircraft fuselage of FIG. 2 is shown having both insulating material 6 and an insulation layer 17, it is envisaged that the insulation material 6 may be done away with altogether if the insulation layer 17 is provided in a sufficient amount. In conjunction with the support layer 15, the overall weight of elements required for heating and insulating the aircraft cabin could be similar or reduced compared with conventional aircraft structures. Even if the insulation material 6 cannot be done away with entirely, a further benefit of the present invention is that, by reducing the thickness of insulation required, the internal cabin space can be increased for a given fuselage cross-section. This is especially beneficial in critical areas of the fuselage cross-section such as the height between the cabin panelling and the top of any passenger seats fitted in the cabin.

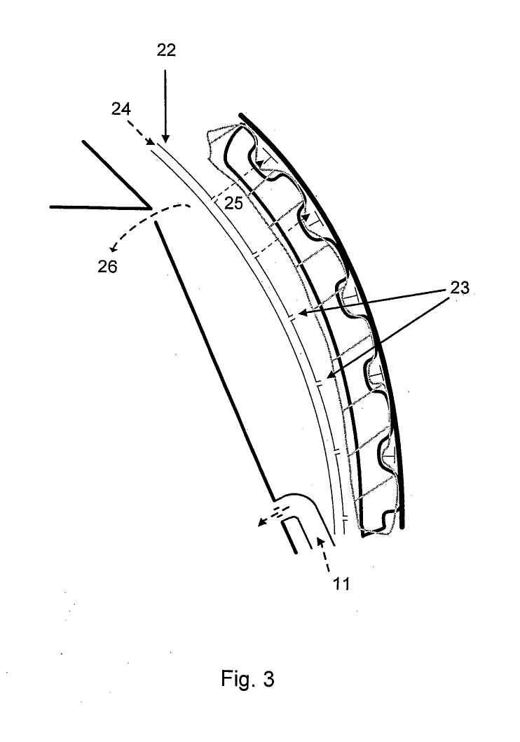

A second embodiment of the invention will now be described with reference to FIG. 3. The aircraft fuselage shell has a similar structure to that of FIG. 1. In addition, a pipe 22 is mounted adjacent the fuselage shell structure. In this context, “adjacent” means “immediately adjacent” or “near to”. Air is directed through openings 23 in pipe 22. Ambient air taken from outside the aircraft engines and heated by the engines through heat exchangers using the “hot end” of the engines as a heat source is pressurised and then passed through pipe 22 as indicated by arrow 24. Upon exiting the pipe 22 through openings 23 the heated air is passed over the interior side of the fuselage shell structure, as indicated by arrows 25. The air can be hotter than the desired cabin air temperature as it will heat the fuselage shell structure before dissipating throughout the cabin. The heated fuselage shell structure will then dissipate heat to the ambient airflow through surface 2. The effect of passing air over the fuselage shell structure in such a manner increases the pressure in cavity 14 above that of the cabin itself. The flow of air through gaps 12 described with reference to FIG. 1 will therefore be in the direction of arrow 26, i.e. from the fuselage shell structure towards the cabin. This has the desired effect of retaining moist air within the cabin itself, whilst maintaining the fuselage shell structure in a substantially ice-free, dry condition. Air-conditioning flows as indicted by arrow 11 may still be required to maintain the cabin environment at the desired temperature and humidity. If the ducting 10 were to be removed, it would be necessary to, for example, be able to pass air that had been cooled by the aircraft's air conditioning packs through pipe 24 (in addition to the heated air) on occasions when the cabin air is hotter than desired.

The ambient air taken from outside the aircraft engines and heated by the aircraft engines by passing it through a heat exchanger drawing heat from the turbine section of the engines may be at a temperature that is in excess of that desired to warm conventional aircraft shell structures, as the more heat that can be exchanged from the engine the cooler it will run and the greater the improvements in time on wing and fuel burn over time will be. This may be the case even if significant amounts of heat can be rejected keeping the aircraft fuselage shell structure warm and substantially ice free whilst maintaining the aircraft cabin at a temperature comfortable for occupants.

It is further intended that piping for transporting the heated air from the aircraft engine to the fuselage is routed via the leading edge section of the aircraft wing so that sufficient heat loss to the leading edge wing section occurs to substantially prevent ice formation on the wing leading edge. This effectively provides for all or a portion of the wing leading edge a “permanently on” anti-icing system. Other ice sensitive areas of the aircraft could be similarly heated such as the control surfaces.

It is well known that when operating aircraft in extreme winter weather conditions, a significant time must be spent in preparing the aircraft for flight to ensure that the aircraft fuselage is free from significant accumulations of snow and ice. Various methods for removing such snow and ice include heating hangers, mobile heating panels and spraying the aircraft fuselage with de-icing chemicals. Each of these methods are both time intensive and expensive and the invention may eliminate or reduce the requirement for any of these with respect to the fuselage since the fuselage heating according to the invention may be turned on both when the aircraft is in flight and also when it is on the ground thus negating, or at least alleviating, the requirement for further de-icing methods, providing significant time and cost savings.

The fuselage heating of the invention further has significant environmental implications since heat energy is directed into the fuselage structure from within to prevent frost, snow and ice contamination bonding onto the exterior of the fuselage structure and so the use of environmentally unfriendly de-icing chemicals may be negated entirely, especially if this method of fuselage heating is combined with other heating systems for de-icing aerodynamic surfaces.

In addition to the purely exemplary embodiments of the invention described above with reference to FIGS. 2 and 3, various alternative embodiments are envisaged within the scope of the invention which is defined by the appending claims.

1-34. (canceled)

35. An aircraft fuselage comprising:
an aircraft fuselage shell structure enclosing an interior space; and
a heater disposed in the enclosed space adjacent the aircraft fuselage shell structure for supplying heat energy to air occupying the enclosed space,
wherein the heater is a heater mat comprising one or more heating elements supported by a support layer, the support layer being permeable to water vapour and impermeable to water droplets; and
wherein the heater mat is adapted to drive moisture from air in a region disposed immediately adjacent the structure to air in a region disposed from the structure within the enclosed space, thereby substantially preventing ice formation on the interior of the structure when the exterior of the structure is exposed to temperatures in the region of −35° C. to −85° C.

36. An aircraft fuselage according to claim 35, wherein the support layer is an insulation layer.

37. An aircraft fuselage according to claim 35, further comprising an insulation layer.

38. An aircraft fuselage according to claim 37, wherein the insulation layer is disposed on one side of the support layer so as to be nearest the aircraft fuselage shell structure.

39. An aircraft fuselage according to claim 36, wherein the insulation layer is absorbent.

40. An aircraft fuselage according to claim 36, wherein the insulation layer is made of Mylar, glass fibre or foam.

41. An aircraft fuselage according to claim 35, wherein the heating element is a heat pipe or an electrical heating element.

42. An aircraft fuselage according to claim 41, wherein the heat pipe contains fluid heated by an aircraft engine when in use.

43. An aircraft fuselage according to claim 35, wherein the heater mat is disposed between the aircraft fuselage shell structure and an aircraft interior cabin fitting.

44. An aircraft fuselage according to claim 35, wherein the heater mat includes an air valve for permitting equalisation of air pressures across the heater mat.

45. An aircraft including an aircraft fuselage according to claim 35.

46. A method of heating an aircraft fuselage, comprising the step of supplying heat energy to air occupying an interior space enclosed by an aircraft fuselage shell structure so as to drive moisture from air in a region disposed immediately adjacent the structure to air in a region disposed from the structure within the enclosed space, thereby substantially preventing ice formation on the interior of the structure when the exterior of the structure is exposed to temperatures in the region of −35° C. to −85° C., wherein the heat energy is supplied by energising a heater mat comprising one or more heating elements supported by a support layer disposed adjacent the aircraft fuselage shell structure, the support layer being permeable to water vapour and impermeable to water droplets.

47. A method of heating an aircraft fuselage according to claim 46, wherein the heat energy supplied is bled from a gas path of an aircraft engine.

48. A method of heating an aircraft fuselage according to claim 46, wherein the heat energy supplied is transferred to ambient air from a hot section of an aircraft engine.

49. A method of heating an aircraft fuselage according to claim 46, wherein the heater mat forms a boundary between warmer, moist air on an interior side thereof and cooler, dryer air on a fuselage structure side thereof, such that moisture on the fuselage side that condenses on the heater mat is wicked through the heater mat to the interior side.

50. A method of heating an aircraft fuselage according to claim 49, further comprising the step of operating an air valve for equalising air pressures across the heater mat.

51. A method of heating an aircraft fuselage according to claim 46, further comprising the step of additionally heating the air in the region disposed from the structure within the enclosed space by secondary heating means.
